(19) United States
(12) Patent Application Publication
(10) Pub. No.: US 2025/0287344 A1
(43) Pub. Date: Sep. 11, 2025

(54) REFERENCE SIGNAL MEASUREMENTS FOR HYBRID SERVICES

(71) Applicant: Lenovo (United States) Inc., Morrisville, NC (US)

(72) Inventors: Robin Rajan Thomas, Bad Nauheim (DE); Ahmed Hindy, Aurora, IL (US)

(21) Appl. No.: 19/215,210

(22) Filed: May 21, 2025

(51) Int. Cl. H04W 64/00; H04B 7/06; H04L 5/00; H04W 24/10

(52) U.S. Cl. CPC H04W 64/00; H04B 7/0626; H04L 5/0051; H04W 24/10

(57) ABSTRACT

Various aspects of the present disclosure relate to enhancing measurement gap configurations for measurement entities, such as user equipment (UEs) performing positioning, sensing, or other target tracking services or measurement operations. For example, a UE may be configured to perform positioning/sensing measurements based on a measurement gap that is enhanced for the measurements (e.g., a measurement gap time period and/or periodicity), where a measurement gap configuration is aligned with a reference signal configuration. The measurement gap may be associated with parameters that facilitate use of the reference signal for both communication and target tracking (e.g., positioning, sensing).

### TECHNICAL FIELD

The present disclosure relates to wireless communications, and more specifically to reference signal (RS) measurements for hybrid services.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, processors, and systems that perform RS measurements for hybrid services, such as positioning/sensing and communications within a unified network framework. The methods, apparatuses, processors, and systems of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to receive a measurement gap configuration for performing target tracking measurements within a measurement gap using an RS, receive an RS resource configuration for the RS, and perform one or more target tracking measurements within the measurement gap based on the measurement gap configuration and using the using the RS based on the RS resource configuration.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to receive a measurement gap configuration for performing target tracking measurements within a measurement gap using an RS, receive an RS resource configuration for the RS, and perform one or more target tracking measurements within the measurement gap based on the measurement gap configuration and using the using the RS based on the RS resource configuration.

A method performed or performable by the UE is described. The method may comprise receiving a measurement gap configuration for performing target tracking measurements within a measurement gap using an RS, receiving an RS resource configuration for the RS, and performing one or more target tracking measurements within the measurement gap based on the measurement gap configuration and using the using the RS based on the RS resource configuration.

In some implementations of the UE, processor, and method described herein, the UE, processor, and method may further be configured to, capable of, performed, performable, or operable to receive a timing configuration that includes a window periodicity, a window length, or a window offset, and perform the target tracking measurements based at least in part on the timing configuration.

In some implementations of the UE, processor, and method described herein, the timing configuration includes a positioning measurement time configuration (PMTC) or a sensing measurement timing configuration (SeMTC) that is associated with measuring the RS during performance of the one or more tracking measurements.

In some implementations of the UE, processor, and method described herein, to perform the one or more target tracking measurements, the UE, processor, and method may further be configured to, capable of, performed, performable, or operable to perform channel state information reference signal (CSI-RS) measurements for positioning or sensing operations.

In some implementations of the UE, processor, and method described herein, the RS resource configuration is a CSI-RS time-frequency resource configuration.

In some implementations of the UE, processor, and method described herein, the CSI-RS measurements include: Reference Signal (RS) time difference (RSTD) measurements, time-of-arrival (TOA) measurements, UE reception-transmission (Rx-Tx) time difference measurements, base station gNB Rx-Tx time difference measurements, reference signal reference power (RSRP) measurements, per-path reference signal reference PP (RSRPP) measurements, sample-based reference signal time difference (RSTD) measurements, sample-based UE Rx-Tx time difference measurements, doppler measurements, doppler difference measurements, angle of departure (AoD) measurements, angle of arrival (AoA) measurements, and combinations thereof.

In some implementations of the UE, processor, and method described herein, the UE, processor, and method may further be configured to, capable of, performed, performable, or operable to transmit a request to a network entity to request the measurement gap and receive, from the network entity, the measurement gap configuration.

In some implementations of the UE, processor, and method described herein, the UE, processor, and method may further be configured to, capable of, performed, performable, or operable to transmit a request to a network entity to activate the measurement gap, and receive, from the network entity, an activation signal.

In some implementations of the UE, processor, and method described herein, the UE, processor, and method may further be configured to, capable of, performed, performable, or operable to transmit a request to a network entity to deactivate the measurement gap during performance of the target tracking measurements, and receive, from the network entity, a deactivation signal.

In some implementations of the UE, processor, and method described herein, the measurement gap configuration includes an operation type associated with the measurement gap.

In some implementations of the UE, processor, and method described herein, the measurement gap configuration includes a list of multiple measurement gaps, and wherein each measurement gap of the list of multiple measurement gaps is associated with an operation type.

In some implementations of the UE, processor, and method described herein, the measurement gap configuration includes a frequency band associated with the measurement gap, whether the measurement gap is associated with a service type, priority, or gap sharing indication.

In some implementations of the UE, processor, and method described herein, the measurement gap configuration includes a measurement gap length parameter and a measurement gap timing parameter.

In some implementations of the UE, processor, and method described herein, the measurement gap configuration includes a cell identifier.

In some implementations of the UE, processor, and method described herein, the measurement gap configuration and the RS resource configuration are received via radio resource control (RRC) signaling or network access stratum (NAS) signaling.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to transmit a measurement gap configuration for performing target tracking measurements within a measurement gap using an RS to a UE, transmit an RS resource configuration to the UE, and receive one or more target tracking measurements from the UE.

A method performed or performable by the network entity is described. The method may comprise transmitting a measurement gap configuration for performing target tracking measurements within a measurement gap using an RS to a UE, transmitting an RS resource configuration to the UE, and receiving one or more target tracking measurements from the UE.

In some implementations of the network entity and method described herein, the one or more target tracking measurements include CSI-RS measurements for positioning or sensing operations.

In some implementations of the network entity and method described herein, the network entity is a network function (NF) or a base station.

### BRIEF DESCRIPTION OF THE DRAWINGS

FIG. 1 illustrates an example of a wireless communications system in accordance with aspects of the present disclosure.

FIG. 2 illustrates an example of a measurement gap configuration in accordance with aspects of the present disclosure.

FIG. 3 illustrates an example of a signaling diagram in accordance with aspects of the present disclosure.

FIG. 4 illustrates another example of a signaling diagram in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

A wireless communications system may employ CSI-RSs for a variety of functions, such as channel measurements, beam precoding and management, and so on. In addition, the use of CSI-RSs may be enhanced to support hybrid services, where a CSI-RS is deployed for joint communications and positioning. For example, a CSI-RS that is configured for target tracking (e.g., via a tracking reference signal (TRS)) may perform as a reference signal for positioning, sensing, or other target tracking services.

In some cases, the CSI-RS may be utilized to perform intra-frequency and/or inter-frequency measurements using a measurement gap. A measurement gap may refer to a time period where a measurement entity (e.g., a UE) stops communications (e.g., reception and/or transmission) to performs measurements, such as positioning or sensing measurements. Thus, the UE may perform gap-assisted measurements within the measurement gap.

While certain measurements (e.g., CSI reference signal received power (CSI-RSRP) and CSI reference signal received quality (CSI-RSRQ)) are currently supported using a measurement gap, RS measurements associated with or used for positioning and/or sensing may lack measurement gap support. For example, the wireless communications system may not be able to utilize CSI-RS measurements for positioning, sensing, or other hybrid services without configuring a measurement entity (e.g., a UE) with measurement gap parameters associated with the hybrid services. As another example, the measurement entity may lack capabilities for using CSI-RSs for hybrid services measurements.

Various aspects of the present disclosure relate to enhancing measurement gap configurations for measurement entities, such as UEs performing positioning, sensing, or other target tracking services or operations. For example, a UE may be configured to perform positioning/sensing measurements based on a measurement gap that is enhanced for the measurements (e.g., a measurement gap time period and/or periodicity is based on a RAT-dependent measurement), where a measurement gap configuration is aligned with an RS configuration, such as a CSI-RS configuration. Thus, the measurement gap may be associated with parameters that facilitate use of the RS (e.g., the CSI-RS) for both communication and target tracking (e.g., positioning, sensing).

In doing so, the wireless communications system may support inter-frequency positioning and/or sensing measurements (e.g., between neighbor cells), the use of a measurement gap for different RS measurements, and a framework for joint communication and positioning, sensing, or other target tracking operations, among other benefits.

Aspects of the present disclosure are described in the context of a wireless communications system.

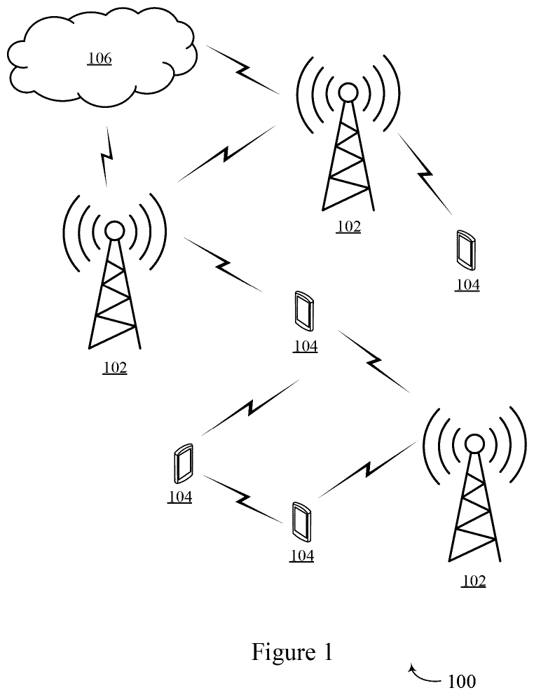

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, one or more NE 102 may provision multiple sets of resources (e.g., time and frequency random access resources) to one or more UEs 104, where each set of resources of the multiple sets of resources is associated with selection criteria. By way of example, an NE 102 may determine selection criteria for each of one or more sets of resources of a plurality of sets of resources for random access, and transmit, to a UE 104, a configuration of the plurality of sets of resources for random access. The UE 104 may receive, from the NE 102, the configuration of the plurality of sets of resources for random access. In some examples, the UE 104 may select a set of resources of a plurality of sets of resources for random access based at least in part on criteria, and perform random access based at least in part on the selected set of resources.

As described herein, the wireless communications system 100 facilitates the use of RS measurements for hybrid services (e.g., communications and positioning, sensing, or other tracking operations) by enhancing the configuration of a measurement gap utilized during the performance of the hybrid services. In some cases, a measurement entity (e.g., the UE 104 and/or the NE 102, such as a gNB or TRP) is configured with a measurement gap by a configuration entity (e.g., the NE 102 or a function within the CN 106). The UE 104, via the measurement gap configuration, performs tracking measurements (e.g., positioning, sensing, and so on) within a measurement gap using an RS, which is based on an RS resource configuration. The tracking measurements within the measurement gap may be referred to as gap-assisted measurements.

In some cases, tracking operations may be performed to identify and/or determine a position or location of a UE or other device, such as a target UE or target device. For example, a tracking operation performed by the UE 104 (or another measurement entity) may measure, using an RS (e.g., a CSI-RS) within a measurement gap, position or location information for the target UE/device, such as two-dimensional (2D) or three-dimensional (3D) absolute position information, 2D/3D relative position information, distance information, direction information, range information, relative distance/range/direction information, and so on.

In other cases, target tracking operations may be performed to identify or otherwise sense an object or device (or a position of an object or device) at or within a location. For example, a target tracking operation performed by the UE 104 (or another measurement entity) may sense, using an RS (e.g., a phase tracking RS (PT-RS) or demodulation RS (DM-RS)) within a measurement gap, the position of an object or device at or within a location.

The enhancement of a measurement gap, in some examples, may support RS-based measurements for target tracking operations and services, such as positioning and sensing operations. For example, the UE 104 may perform L1 measurements based on an RS (e.g., a TRS) via a measurement gap, which may be otherwise limited to certain uses (e.g., synchronization signal block (SSB) detection or downlink positioning reference signals (DL-PRSs)).

The measurement entity (e.g., the UE 104, a gNB, a TRP, and so on) may perform intra-frequency measurements (e.g., where the CSI frequency/bandwidth is within limits of a serving cell and the subcarrier spacing (SCS) of serving and neighbor cells is the same) or inter-frequency neighbor cell measurements, in addition to serving cell measurements (e.g., CSI measurements).

In some examples, the UE 104 may determine that a configured or indicated measurement gap (or gap period) is for a subset of known RAT-independent measurement types (e.g., RSTD, TOA, Rx-Tx time difference, RSRP, and so on) that are based on communication-based RSs (e.g., the CSI-RS). In some cases, a measurement gap period or other characteristics may be enabled for or specific to a RAT-dependent measurement.

The measurement gap may be an interval in which a measurement entity performs measurements for intra-frequency NR cells, inter-frequency NR cells, inter-RAT E-UTRAN cells, intra-frequency 6G cells, inter-frequency 6G cells, and so on. The measurement gap, having a pre-defined time window and/or duration, may have various configuration parameters, including: Absolute Radio Frequency Channel Number (ARFCN), Physical Cell Identity (PCI), New Cell Global Identity (NCGI), TRP ID, a UE Measurement Gap Pattern ID (e.g., an ID that uniquely identifies a UE measurement gap capable of performing communication-based RS for positioning), a measurement gap length (MGL), which defines a length in time (e.g., ms, sec, and so on) of the measurement gap to perform communication-based RS measurements for joint communication and positioning), a measurement gap repetition period (MGRP), which defines a periodic interval for which the configured measurement gap instance is repeated for communication-based RS measurements, a measurement gap timing advance (MGTA), which defines a time duration where a UE may start to perform communication-based RS measurements, and so on.

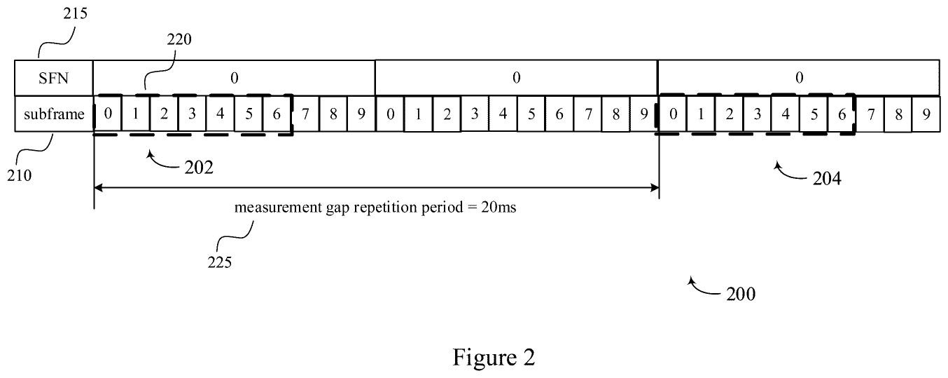

Further, the measurement gap may be defined via one or more parameters, including a start time, an end time, a periodicity, a time interval length, the MGRP, the MGTA, and so on. FIG. 2 illustrates an example of a measurement gap configuration 200 in accordance with aspects of the present disclosure. The measurement gap configuration 200, as shown, is configured to facilitate a UE performing positioning measurements.

For example, 6 subframes 210 within a subframe number (SFN) 215 may define a length 220 of a measurement gap (e.g., the MGL=6 ms). In some cases, the length 220 may be based on a duration for performing measurements (e.g., 4-5 subframes) and an RF-re-tuning time (e.g., 1 subframe). The periodicity 225 may be defined as a time period from a start point of a first measurement gap 202 to a start point of a second measurement gap 204. As shown, the periodicity, or MGRP, is 20 ms (where every 2^{nd} slot at the SCS=15 kHz).

In some examples, the measurement entity may receive various parameters that define or identify the measurement gap. Example parameters include: T and gapOffset, where T=MGRP/10 and subframe=gapOffset mod 10 (e.g., gapOffset=0, as depicted in FIG. 2, indicates that the measurement gap 202 starts at subframe 0). The parameter gapOffset may be defined with respect to a reference time or initialization time of an applicable base station (e.g., gNB, xNB, TRP, and so on) which may transmit the CSI-RS for positioning, sensing, or other target tracking operations.

In some examples, the measurement entity may receive or have a pre-installed/pre-loaded pre-configured measurement gap for performing target tracking measurements using an RS. In some cases, the pre-configured measurement gap may be activated or deactivated based on received signals (e.g., DCI, DL MAC-CE) and/or positioning/sensing protocols at the measurement entity. For example, the measurement entity may include multiple concurrent pre-configured measurement gaps to perform RS-based target tracking measurements. Some or all of the pre-configured measurement gaps may fully or partially overlap, such that the measurement entity may introduce a delay (e.g., a few ms) for activation/deactivation when the pre-configured measurement gaps fully or partially overlap.

As another example, a configured measurement gap may collide with (or otherwise impact) other measurement gaps, such as pre-configured measurement gaps and/or previously configured measurement gaps. The measurement entity may utilize collision rules or prioritization rules to manage collisions or use of multiple conflicting measurement gaps (e.g., a newly configured measurement gap is used before a pre-configured measurement gap).

In some examples, the measurement entity may perform target tracking measurements using multiple groups of RSs (e.g., groups of CSI-RSs), where each group of RSs is associated with a frequency band. For example, a single group of CSI-RSs may be associated with a specific frequency offset value, a time offset value, and so on, where the values are distinct from values for other groups of CSI-RSs. As another example, each group of CSI-RSs may be associated with a distinct or specific non-zero power (NZP) CSI-RS resource set.

In some examples, the measurement entity may perform target tracking measurements using an RS that is configured with a positioning parameter (e.g., indicated as part of an RS resource configuration, such as a CSI-RS configuration). In some cases, the RS resource configuration may supersede or override a Cell Discontinuous Transmission (DTX) configuration (e.g., defining a DTX inactive period) for a cell. Thus, the measurement entity may perform target tracking measurements based on its RS resource configuration and/or measurement gap configuration, regardless of whether an associated cell is within a defined DTX inactive period.

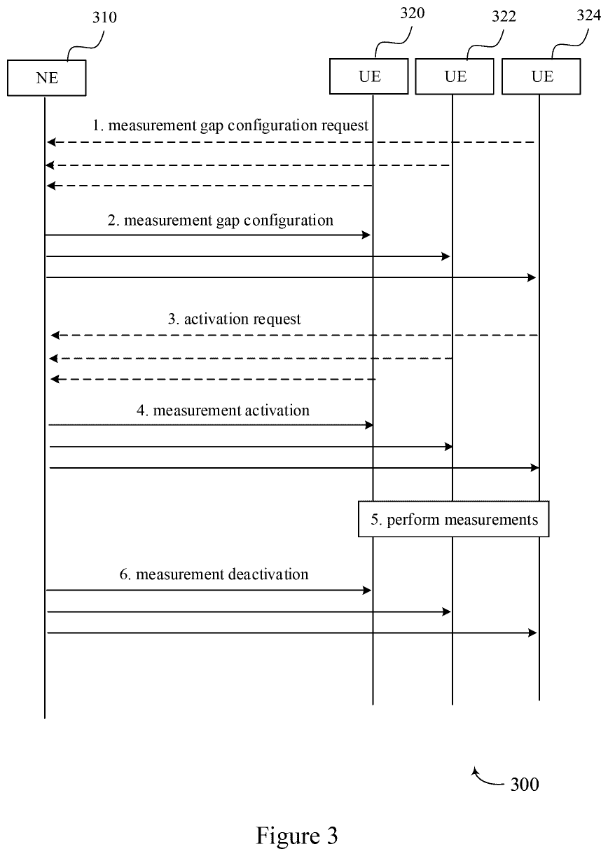

In some examples, measurement gaps are activated and/or configured for multiple cells (in addition to a serving cell), such as for one or more UEs 104 to perform target tracking operations and other hybrid services for the multiple cells. FIG. 3 illustrates an example of a signaling diagram 300 in accordance with aspects of the present disclosure.

The signaling diagram 300 may implement or be implemented by aspects of the wireless communications system 100. The signaling diagram 200 may implement or be implemented by an NE 310 (e.g., a CN 106 entity, such as an LMF, RAN, and so on) and UEs 320, 322, 324 (or other measurement entities or positioning reference units (PRUs)), which may be examples of the UE 104, and the NE 102 as described with reference to FIG. 1. Alternative examples of the following may be implemented, where some processes are performed in a different order than described or are not performed. In some cases, processes may include additional features not mentioned below, or further processes may be added.

The signaling diagram 300 may represent and/or reflect a framework within which a UE (e.g., the UE 320, 322, 324) may request and/or receive a measurement gap configuration and activation/deactivation commands for performing target tracking measurements (e.g., L1 CSI-RS or other communication-related RS positioning measurements).

At step 1, the UEs 320, 322, 324 may transmit a measurement gap configuration request to the NE 310. For example, the UE 320 may transmit the measurement gap configuration request while performing a requested positioning/location or sensing measurement using measurement gaps are either not configured or not of sufficient duration/length and/or if the UE 320 has to acquire subframe and slot timing of a target system before requesting measurement gaps for inter-RAT positioning or sensing measurements. The UEs 320, 322, 324 may transmit the request via RAN-RAN signaling (e.g., an Xn interface), RAN-LMF-RAN signaling (e.g., NRPPa), and/or a dedicated interface between a new sensing function (SF) entity and one or more RAN nodes.

At step 2, the NE 310 transmits a measurement gap configuration to the UEs 320, 322, 324. As described herein, the measurement gap configuration is for performing target tracking measurements (e.g., positioning, sensing) within a measurement gap using the RS, and is independent of (and transmitted separately from) a RS configuration (e.g., a CSI-RS configuration).

For example, the NE 310 may configure a measurement gap based on CSI-RS transmissions, measurements to be performed, a number of target objects to be measured or detected, and so on. As described herein, the measurement gap configuration may include one or more parameters, including a measurement gap ID, MGL, MGRP, gapOffset, and so on. In some cases, the implementation, the UEs 320, 322, 324 may receive and store a pre-configured measurement gap for future use. The NE 310 may transmit the measurement gap configuration via UE-specific signaling, broadcast signaling, and so on. Example parameters associated with a configured measurement gap are depicted in Table 1, as follows.

| Parameter | Value | | Description |
|---|---|---|---|
| >gapAssociationCSI-RS | {True, False} | | Indicates that CSI-RS |
| | | | measurement is associated |
| | | | with this measurement gap. |
| | | | The configuration entity may |
| | | | only include this field for one |
| | | | per-TRP gap or for one per-FR |
| | | | gap. If concurrent gap (e.g., |
| | | | one of the gap combinations as |
| | | | pre-defined by certain MG ID, |
| | | | MGL and MGRP values or a |
| | | | new gap combination for |
| | | | TRPs) is configured and no |
| | | | gap is configured with this |
| | | | field, the positioning (or |
| | | | sensing) measurement is |
| | | | associated with the gap |
| | | | configured via GapConfig |
| | | | (without suffix), if available. |
| >gapAssociationCommunication | {True, False} | | Indicates that the gap is used |
| SensingandPositioningRS | | | for communication, |
| | | | positioning and/or sensing |
| | | | operations, or combinations |
| | | | thereof. It can be used for the |
| | | | measurement of PRS, SRS, |
| | | | new sensing RSs, SSB, CSI- |
| | | | RS, TRS and other |
| | | | communication reference |
| | | | signal types. |
| >gapFR1 | | | Indicates measurement gap |
| | | | configuration that applies to |
| | | | FR1 only. The applicability of |
| | | | the FR1 measurement gap is |
| | | | according to e.g., pre-defined |
| | | | values for MG ID, MGL and |
| | | | MGRP or a new gap |
| | | | combination for TRPs. |
| >gapFR2 | | | Indicates measurement gap |
| | | | configuration that applies to |
| | | | FR2 only. The applicability of |
| | | | the FR2 measurement gap is |
| | | | according to e.g., pre-defined |
| | | | values for MG ID, MGL and |
| | | | MGRP or a new gap |
| | | | combination for TRPs. |
| >gapFR3 | | | Indicates measurement gap |
| | | | configuration that applies to |
| | | | FR3 only. The applicability of |
| | | | the FR3measurement gap is |
| | | | according to e.g., pre-defined |
| | | | values for MG ID, MGL and |
| | | | MGRP or a new gap |
| | | | combination for TRPs. (all |
| | | | subbands) |
| >gapOffset | The value range is an INTEGER | | Value gapOffset is the gap |
| | interval expressed in ms, e.g., | | offset of the gap pattern with |
| | {0, . . . , 159} | | MGRP indicated in the field |
| | | | mgrp. |
| >measGapId | A defined ID | | The ID of this TRP |
| | | | measurement gap |
| | | | configuration. |
| >mgl | ENUMERATED value range in ms | | Value mgl is the measurement |
| | e.g., {1, . . . , 20} | | gap length in ms of the |
| | | | measurement gap. |
| >mgrp | ENUMERATED value range in ms | | Indicates the TRP MGRP |
| | e.g., {20, 40, 60, 80, 160} | | |
| >mgta | ENUMERATED value range in ms | | Indicates the measurement gap |
| | | | timing advance in ms |
| >CSIposMeasGapPreConfigToAddModList | | | List of preconfigured |
| | | | measurement gap that support |
| | | | L1 CSI-RS for positioning or |
| | | | sensing to add and/or modify. |
| | | | All the gaps configured are |
| | | | associated with the CSI-RS |
| | | | measurements for positioning |
| | | | e.g., RSTD, gNB/xNB-RxTx |
| | | | Time Difference, RS-RSRP, |
| | | | one-way doppler, two-way |
| | | | doppler, Azimuth/Elevation |
| | | | AoD and AoA and RS- |
| | | | RSRPP. |
| >CSIposMeasGapPreConfigToReleaseList | | | List of preconfigured |
| | | | measurement gap that support |
| | | | L1 CSI-RS for positioning or |
| | | | sensing to release. All the gaps |
| | | | configured are associated with |
| | | | the CSI-RS measurements for |
| | | | positioning e.g., RSTD, |
| | | | gNB/xNB-RxTx Time |
| | | | Difference, RS-RSRP, one- |
| | | | way doppler, two-way |
| | | | doppler, Azimuth/Elevation |
| | | | AoD and AoA and RS- |
| | | | RSRPP. |
| >preConfigInd | Flag | | Indicates whether the |
| | | | measurement gap is a pre- |
| | | | configured measurement gap. |
| >gapPriority | E.g., Value 1 indicates highest priority, | | Indicates the explicit priority |
| | value 2 indicates second level priority, | | of this measurement gap |
| | and so on | | |
| >gapSharing | | Value | Indicates the measurement gap |
| | | of Y | sharing percentage with regard |
| | measGapSharingScheme | (%) | to legacy RAT, e.g. LTE (E- |
| | ‘00’ | Equal splitting | UTRAN), NR and 6G Radio |
| | ‘01’ | 25 | e.g., 6G of various RS, e.g., |
| | ‘10’ | 50 | SSB, CSI-RS, PRS, SRS, new |
| | ‘11’ | 75 | sensing RS that applies to this |

| | | |
|---|---|---|
| | Note: It is left to gNB/xNB/TRP | configuration. This may be |
| | implementation to determine which | applied to intra-frequency or |
| | measurement gap sharing scheme in | inter-frequency measurements. |
| | the table to be applied, when this IE is | |
| | absent and there is no stored value in | |
| | the field. | |
| | The following sharing allocation of a | |
| | gap holds according to the following | |
| | information and value of Y: | |
| | K_{intra-freq} = 1/Y * 100, | |
| | K_{inter-freq} = 1/(100 − Y) * 100 | |
| >gapType | ENUMERATED, e.g., {perTRP, | Indicates the type of this |
| | perFR1, perFR2, perFR3}. | measurement gap. Value |

per-TRP indicates that it
is a per TRP
measurement gap, value
perFR1 indicates that it is
an FR1 measurement
gap, and/or value perFR2
indicates that it is an FR2
measurement gap and/or
value perFR3 indicates
that it is an FR3
measurement gap

At step 3, the UEs 320, 322, 324 may optionally or additionally, transmit an activation request to the NE 310. For example, the UE 320 may transmit a request for activation of a measurement gap configuration for positioning/sensing measurements based on an RS, such as the CSI-RS.

At step 4, the NE 310 transmits a measurement activation signal to the UEs 320, 322, 324. For example, the NE 310 may transmit a separate measurement gap activation/setup message or command for performing positioning/sensing measurements in response to a received request (step 3) or without receiving a request (e.g., when a measurement gap configuration is already known or to activate a pre-configured measurement gap). The NE 310 may transmit a separate activation message to each of the UEs 320, 322, 324 and/or a common activation to multiple UEs (e.g., broadcast to a group of UEs).

At step 5, the UEs 320 perform measurements (e.g., positioning/sensing L1 measurements). For example, the UE 320 may perform gap-assisted measurements based on a received and/or activated measurement gap configuration and based on receiving a CSI-RS (e.g., a TRS).

At step 6, the NE 310 transmits a measurement deactivation signal to the UEs 320, 322, 324. For example, the NE 310 may send a separate measurement gap deactivation/release message or command for a configured measurement gap after measurements are performed (e.g., at step 5). In some cases, the NE 310 may transmit the measurement deactivation signal after receiving a deactivation request from the UEs 320, 322, 324.

In some cases, a measurement gap (or measurement interval) may be set up for FR1, FR2, or FR3. For example, the FR3, corresponding to a frequency range spanning at least a subset of 6 GHz up to 24 GHz, may be split to two frequency sub-ranges (e.g., FR3-1, and FR3-2) corresponding to a lower range and upper range of carrier frequency values (e.g., FR3-1 corresponds to 6-10 GHz, and FR3-2 corresponds to 10-24 GHz). In other cases, the two frequency sub-ranges in FR3 are merged to FR1 and FR2, where the FR3-1 is merged with a legacy FR1 (e.g., 0.5 GHz to 6 GHz) and defined as FR1-2 and FR1-1, respectively, and FR3-2 is merged with a legacy FR2 (e.g., 24 GHz and beyond) and defined as FR2-0 and FR2-1, respectively.

In some cases, a measurement gap may be configured up to a specific limit of a number of measurement gaps. Once the limit is reached (e.g., a maximum number or quantity), other measurement gaps may be released, and the measurement entity may apply a new or unused measurement gap configuration. Furthermore, when there are multiple active measurement gaps for different types of measurements (e.g., operation types), the different measurements may be performed concurrently on a same active configured measurement gap.

In some examples, a measurement gap configured for assisting in target tracking measurements (e.g., the positioning or sensing measurements) may also be utilized for other types (e.g., operation types) of communication measurements, such as radio resource management (RRM), SSB/CSI-RS, cross link interference, mobility measurements, synchronization measurements across resources (e.g., over a time domain, a frequency domain, and/or a phase domain) and so on. For example, the measurement gap may be a common or shared measurement gap for various measurements that is configured as a hybrid service measurement gap (e.g., for gap-assisted joint positioning and communication and/or joint communication and sensing).

In some cases, the measurement entity may switch from a current active BWP of a serving cell to a configured measurement gap to perform positioning or sensing measurements. The switching time may be known to the measurement entity and/or provided from the NE 310, based on whether inter-frequency or intra-frequency RS measurements for positioning or sensing are to be performed. Thus, the measurement entity may perform positioning or sensing measurements from other NEs 102 or RATs, where the RS resources extend beyond an active BWP. The measurement entity, capable for multi-carrier communication of data over DL, UL, or both, may be configured with the measurement gap that limits the simultaneous measurement for positioning or sensing.

In some examples the RS resource configuration (e.g., a CSI-RS configuration, such as a TRS configuration) may be aligned with various measurement gap configurations or parameters. For example, the alignment may include an alignment of a CSI-RS (e.g., a TRS) physical layer resource configuration with the MGL and the MGRP of the measurement gap. An example alignment is as follows: an MGL={1.5, 3, 3.5, 4, 5.5, 6, 10, 20}ms and an MGRP={20, 40, 80, 160}ms may align with the CSI-RS (e.g., TRS) per slot={1, 2}symbols (also dependent on the TRS SCS) and a TRS periodicity={20}ms. Thus, the CSI-RS (e.g., TRS) per slot duration may align with the MGL and the TRS periodicity may align with the MGRP. Further, the TRS configuration may include additional TRS periodicity values for robust sensing or positioning measurements.

In some examples, a PMTC and/or a SeMTC, which may be part of the measurement gap, may be employed to notify measurement entities about periodicity information or timing information (e.g., an RS duration, a number of RS symbols, and so on) for RSs employed for positioning or sensing (e.g., the CSI-RS, a DL-PRS, an SRS, and so on). The PMTC or SeMTC may include various configuration parameters, including a measurement window periodicity, a measurement window duration, a measurement window slot/SFN offset, and so on.

In some cases, the number of PMTCs or SeMTCs per carrier or frequency layer may be limited. In some cases, the PMTC or SeMTC may be applicable for RRC_CONNECTED, RRC_IDLE and RRC_INACTIVE states. In some cases, the PMTC or SeMTC periodicities may be different from the transmission RS periodicities (e.g., and not match the RS transmission periodicities.

As described herein, the NE 310 may transmit, as part of the measurement gap configuration, the PMTC and/or the SeMTC to a measurement entity. The MGL of the measurement gap may be defined, for different values, to align with the duration or length of the PMTC/SeMTC. In some cases, multiple PMTCs/SeMTCs may be associated with a single measurement gap configuration, such as when the MGL is sufficient in length for multiple different PMTCs/SeMTCs. In some cases, such as when an RF tuning process occurs during a measurement gap overlaps with the PMTC/SeMTC, the measurement entity may utilize the received measurement gap configuration parameter: an MGTA to advance the start of the RF tuning gap in order to avoid an overlap between the RF tuning time and the start of the PMTC/SeMTC. In some cases, the PMTC or SeMTC may also be applicable to a new or dedicated sensing reference signal.

In some examples, the enhanced measurement gap may support various RS target tracking measurements, including:

RSTD measurements, TOA measurements, UE Rx-Tx time difference measurements, base station gNB Rx-Tx time difference measurements, RSRP measurements RSRPP measurements; sample-based RSTD measurements, sample-based UE Rx-Tx time difference measurements, doppler measurements, doppler difference measurements; AoD measurements, angle of arrival AoA measurements, and combinations thereof. In some cases, the measurement gap may support or assist performance of the various measurements using different RSs, such as RSs for target tracking (positioning, sensing), RSs for beam management, RSs for interference management, RSs for mobility, and so on.

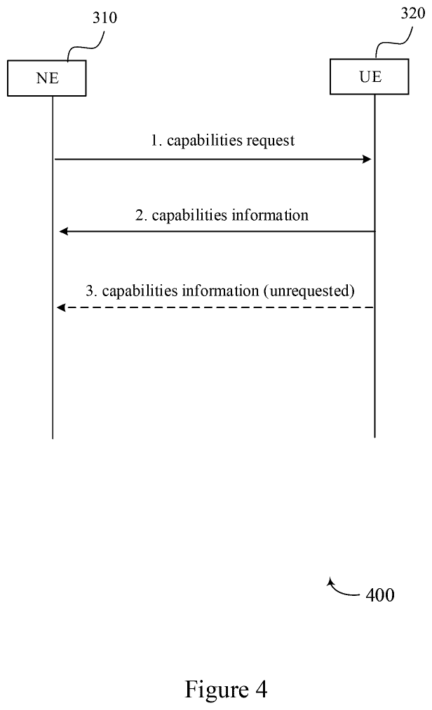

As described herein, the enhanced measurement gap may be part of a measurement gap capability exchange framework (e.g., per-UE/per-FR), which can support gap-assisted RS measurements for positioning, sensing, and/or other hybrid services. FIG. 4 illustrates another example of a signaling diagram 400 in accordance with aspects of the present disclosure.

At step 1, the NE 310 transmits a capabilities request to the UE 320. For example, the NE 310 may transmit request to the UE 320 to determine per-UE or per-FR measurement gap capabilities (of the UE 320 or another target UE) to support CSI-RS measurements for positioning or sensing purposes, as described herein.

At step 2, the UE 320 transmits a capabilities response to the NE 310. For example, the UE 320 may send information identifying the per-UE or per-FR measurement gap capabilities for CSI-RS based measurements for positioning or sensing, joint communication and positioning, joint communication or sensing, and so on, to the NE 310. Alternatively or additionally, the UE 320, at step 3, may send, unrequested, information identifying the per-UE or per-FR measurement gap capabilities for the UE 320 or other target UEs.

In some cases, such as in response to determining the per-UE or per-FR measurement gap capabilities of the UE 320, the NE 310 may configure the per-UE or per-FR measurement gap capabilities of the UE 320, as described herein. For example, the measurement gap configuration may include a per-UE gap applicable to all FR bands or combinations of FR bands, including FR1, FR2 and FR3. A per-FR gap may be a measurement gap specific to a given frequency range (e.g., FR1, FR2 or FR3).

In some cases, such as when the NE 310 is a network function (e.g., an LMF or SF), the entities may communicate via NAS signaling, based on a positioning protocol (LPP) and/or a sensing protocol. In other cases, such as when the NE 310 is a base station (e.g., gNB) or a TRP, the entities may communicate via access stratum (AS) layer signaling, such as RRC signaling.

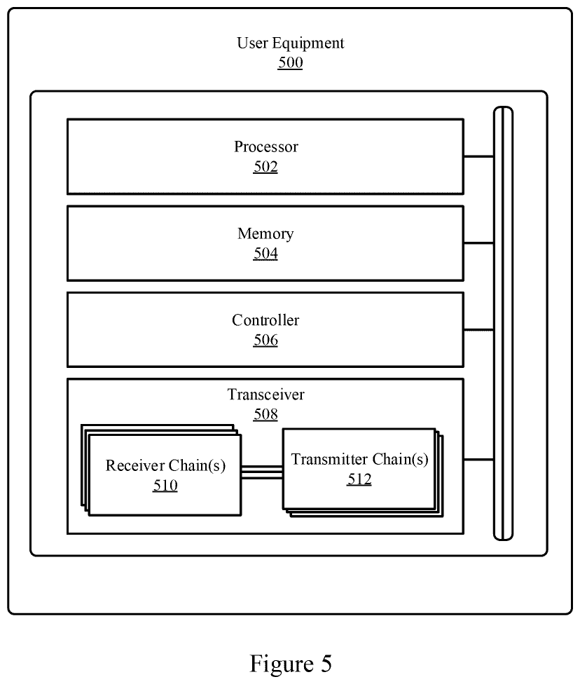

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for receiving a measurement gap configuration for performing target tracking measurements within a measurement gap using an RS, receiving an RS resource configuration for the RS, and performing one or more target tracking measurements within the measurement gap based on the measurement gap configuration and using the using the RS based on the RS resource configuration.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

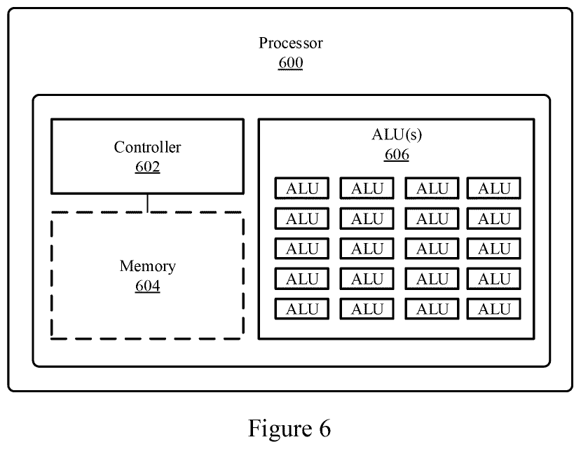

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. For example, the processor 600 may be configured to support a means for receiving a measurement gap configuration for performing target tracking measurements within a measurement gap using an RS, receiving an RS resource configuration for the RS, and performing one or more target tracking measurements within the measurement gap based on the measurement gap configuration and using the using the RS based on the RS resource configuration.

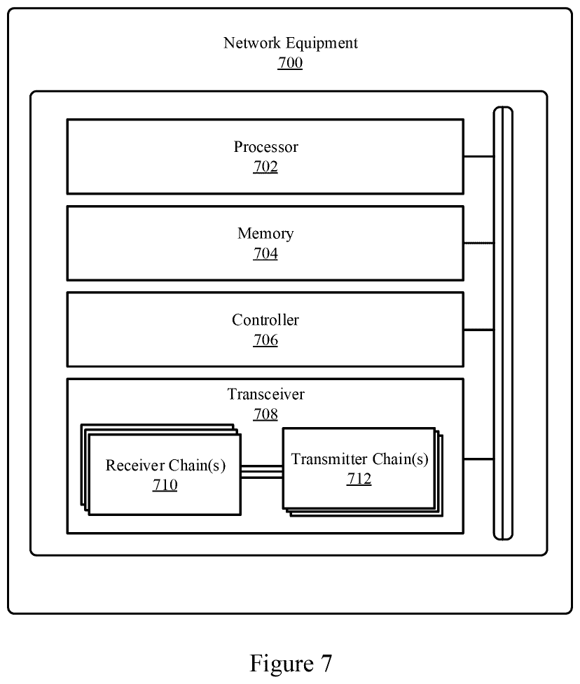

FIG. 7 illustrates an example of a NE 700 in accordance with aspects of the present disclosure. The NE 700 may include a processor 702, a memory 704, a controller 706, and a transceiver 708. The processor 702, the memory 504, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704).

For example, the processor 702 may support wireless communication at the NE 700 in accordance with examples as disclosed herein. The NE 700 may be configured to support a means for transmitting a measurement gap configuration for performing target tracking measurements within a measurement gap using an RS to a UE, transmitting an RS resource configuration to the UE, and receiving one or more target tracking measurements from the UE.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

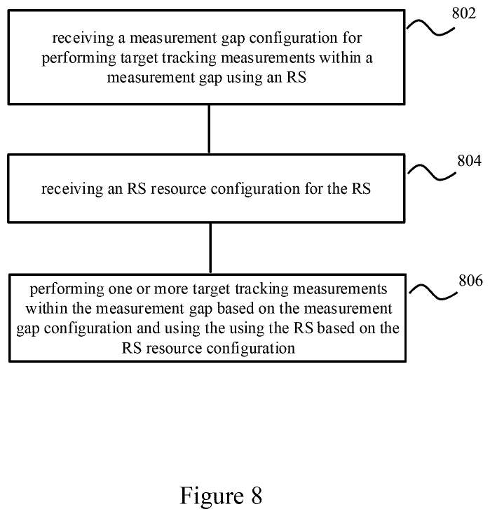

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving a measurement gap configuration for performing target tracking measurements within a measurement gap using an RS. The operations of 802 may be performed in accordance with examples as described herein. In some implementations, aspects of the operations of 802 may be performed by a UE as described with reference to FIG. 5.

At 804, the method may include receiving an RS resource configuration for the RS. The operations of 804 may be performed in accordance with examples as described herein. In some implementations, aspects of the operations of 804 may be performed by a UE as described with reference to FIG. 5.

At 806, the method may include performing one or more target tracking measurements within the measurement gap based on the measurement gap configuration and using the using the RS based on the RS resource configuration. The operations of 806 may be performed in accordance with examples as described herein. In some implementations, aspects of the operations of 806 may be performed by a UE as described with reference to FIG. 5.

It should be noted that the method described herein describes a possible implementation, and that the operations and the steps may be rearranged or otherwise modified and that other implementations are possible.

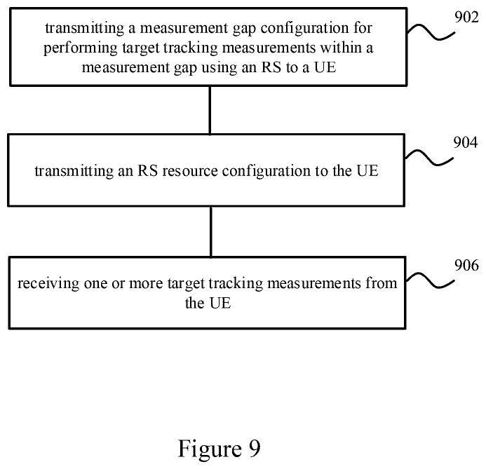

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include transmitting a measurement gap configuration for performing target tracking measurements within a measurement gap using an RS to a UE. The operations of 902 may be performed in accordance with examples as described herein. In some implementations, aspects of the operations of 902 may be performed by an NE as described with reference to FIG. 7.

At 904, the method may include transmitting an RS resource configuration to the UE. The operations of 904 may be performed in accordance with examples as described herein. In some implementations, aspects of the operations of 904 may be performed by an NE as described with reference to FIG. 7.

At 906, the method may include receiving one or more target tracking measurements from the UE. The operations of 906 may be performed in accordance with examples as described herein. In some implementations, aspects of the operations of 906 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive a measurement gap configuration for performing target tracking measurements within a measurement gap using a reference signal (RS);
receive an RS resource configuration for the RS; and
perform one or more target tracking measurements within the measurement gap based on the measurement gap configuration and using the using the RS based on the RS resource configuration.

2. The UE of claim 1, wherein the one or more processors are further individually or collectively configured to cause the UE to:
receive a timing configuration that includes a window periodicity, a window length, or a window offset; and
perform the target tracking measurements based at least in part on the timing configuration.

3. The UE of claim 2, wherein the timing configuration includes a positioning measurement time configuration (PMTC) or a sensing measurement timing configuration (SeMTC) that is associated with measuring the RS during performance of the one or more tracking measurements.

4. The UE of claim 1, wherein, to perform the one or more target tracking measurements, the one or more processors are further individually or collectively configured to cause the UE to:
perform channel state information reference signal (CSI-RS) measurements for positioning or sensing operations.

5. The UE of claim 4, wherein the RS resource configuration is a CSI-RS time-frequency resource configuration.

6. The UE of claim 4, wherein the CSI-RS measurements include:
Reference Signal (RS) time difference (RSTD) measurements;
time-of-arrival (TOA) measurements;
UE reception-transmission (Rx-Tx) time difference measurements;
base station gNB Rx-Tx time difference measurements;
reference signal reference power (RSRP) measurements;
per-path reference signal reference PP (RSRPP) measurements;
sample-based reference signal time difference (RSTD) measurements;
sample-based UE Rx-Tx time difference measurements;
doppler measurements;
doppler difference measurements;
angle of departure (AoD) measurements;
angle of arrival (AoA) measurements;
and combinations thereof.

7. The UE of claim 1, wherein the one or more processors are further individually or collectively configured to cause the UE to:
transmit a request to a network entity to request the measurement gap; and
receive, from the network entity, the measurement gap configuration.

8. The UE of claim 1, wherein the one or more processors are further individually or collectively configured to cause the UE to:
transmit a request to a network entity to activate the measurement gap; and
receive, from the network entity, an activation signal.

9. The UE of claim 1, wherein the one or more processors are further individually or collectively configured to cause the UE to:
transmit a request to a network entity to deactivate the measurement gap during performance of the target tracking measurements; and
receive, from the network entity, a deactivation signal.

10. The UE of claim 1, wherein the measurement gap configuration includes an operation type associated with the measurement gap.

11. The UE of claim 1, wherein the measurement gap configuration includes a list of multiple measurement gaps, and wherein each measurement gap of the list of multiple measurement gaps is associated with an operation type.

12. The UE of claim 1, wherein the measurement gap configuration includes a frequency band associated with the measurement gap, whether the measurement gap is associated with a service type, priority, or gap sharing indication.

13. The UE of claim 1, wherein the measurement gap configuration includes a measurement gap length parameter and a measurement gap timing parameter.

14. The UE of claim 1, wherein the measurement gap configuration includes a cell identifier.

15. The UE of claim 1, wherein the measurement gap configuration and the RS resource configuration are received via radio resource control (RRC) signaling or network access stratum (NAS) signaling.

16. A network entity for wireless communication, comprising:
one or more memories; and
one or more processors coupled with the one or more memories and individually or collectively configured to cause the network entity to:
transmit a measurement gap configuration for performing target tracking measurements within a measurement gap using a reference signal (RS) to a user equipment (UE);
transmit an RS resource configuration to the UE; and
receive one or more target tracking measurements from the UE.

17. The network entity of claim 16, wherein the one or more target tracking measurements include channel state information reference signal (CSI-RS) measurements for positioning or sensing operations.

18. The network entity of claim 16, wherein the network entity is a network function (NF) or a base station.

19. A method performed by a user equipment (UE), the method comprising:
receiving a measurement gap configuration for performing target tracking measurements within a measurement gap using a reference signal (RS);
receiving a RS resource configuration for the RS; and
performing one or more target tracking measurements within the measurement gap based on the measurement gap configuration and using the using the RS based on the RS resource configuration.

20. A method performed by a network entity, the method comprising:
transmitting a measurement gap configuration for performing target tracking measurements within a measurement gap using a reference signal (RS) to a user equipment (UE);
transmitting an RS resource configuration to the UE; and
receiving one or more target tracking measurements from the UE.
